(19) United States
(12) Patent Application Publication
(10) Pub. No.: US 2023/0006514 A1
(43) Pub. Date: Jan. 5, 2023

(54) ROTATION DEVICE

(71) Applicant: IHI Corporation, Tokyo (JP)

(72) Inventors: Tetsuyuki TERAUCHI, Tokyo (JP); Yoshikazu SAKAMAKI, Tokyo (JP)

(73) Assignee: IHI Corporation, Tokyo (JP)

(21) Appl. No.: 17/784,592

(22) PCT Filed: Dec. 11, 2020
(86) PCT No.: PCT/JP2020/046351

§ 371 Date: Jun. 10, 2022

(30) Foreign Application Priority Data
Dec. 12, 2019 (JP) 2019-224749

(51) Int. Cl. H02K 9/193; H02K 1/32; H02K 1/27

(52) U.S. Cl. CPC H02K 9/193; H02K 1/32; H02K 1/27

(57) ABSTRACT

A rotation device includes a rotor; an inlet flow passage that guides a cooling medium toward the outside in a radial direction of the rotor; an axial flow passage that is connected to the inlet flow passage and guides the cooling medium along a rotation axis of the rotor; and an outlet flow passage that is connected to the axial flow passage and guides the cooling medium toward the inside in the radial direction of the rotor. In addition, an outlet of the outlet flow passage is provided on the outside in the radial direction of an inlet of the inlet flow passage in the rotor.

### TECHNICAL FIELD

The present disclosure relates to a rotation device. Priority is claimed on Japanese Patent Application No. 2019-224749, filed Dec. 12, 2019, the content of which is incorporated herein by reference.

### BACKGROUND ART

As an example of a rotation device such as a generator and an electric motor, Patent Document 1 discloses an electric motor using permanent magnets as magnetic poles. Such a rotation device has a configuration in which a rotor is provided with pennanent magnets, and the permanent magnets are held by a shrink ring (magnet holder) provided on the outer periphery of the permanent magnets. In addition, the electric motor of Patent Document 1 is provided with an oil passage that communicates with a hollow portion of a rotor shaft and that guides cooling oil to the vicinity of the outer peripheral surface of the motor rotor.

### DOCUMENT OF RELATED ART

### Patent Document

[Patent Document 1] Japanese Unexamined Patent Application, First Publication No. 2001-016826

### SUMMARY

### Technical Problem

In performing such cooling with the cooling oil, a pump for supplying the cooling oil into the oil passage (cooling flow passage) may be provided. On the other hand, there is a demand for downsizing a system including the rotation device or increasing the degree of freedom in arranging components of the system. However, when a supply device such as a pump is provided, it may be difficult to downsize the system or increase the degree of freedom in arranging the components of the system.

The present disclosure is made in view of the above circumstances, and an object thereof is to provide a rotation device that can make cooling oil flow in a cooling flow passage without depending on a supply device such as a pump.

### Solution to Problem

A rotation device of a first aspect of the present disclosure includes: a rotor; an inlet flow passage that guides a cooling medium toward the outside in a radial direction of the rotor; an axial flow passage that is connected to the inlet flow passage and guides the cooling medium along a rotation axis of the rotor; and an outlet flow passage that is connected to the axial flow passage and guides the cooling medium toward the inside in the radial direction of the rotor. In addition, an outlet of the outlet flow passage is provided on the outside in the radial direction of an inlet of the inlet flow passage in the rotor.

A second aspect of the present disclosure is that the rotation device of the first aspect includes: a rotation shaft protruding from an end surface on the outlet flow passage-side of the rotor in an axial direction of the rotation axis. In addition, the outlet of the outlet flow passage communicates with an outer peripheral surface of the rotation shaft.

A third aspect of the present disclosure is that in the rotation device of the first or second aspect, the axial flow passage is provided with a sealing member that limits the cooling medium from leaking.

### Effects

According to the present disclosure, since an outlet of an outlet flow passage is provided on the outside in the radial direction of an inlet of an inlet flow passage, it is possible to make a cooling medium flow by centrifugal force. In addition, the outlet flow passage is provided, which returns the cooling medium to the inside in the radial direction of a rotor. Thereby, it is possible to provide a rotation device that makes cooling oil flow in a cooling flow passage by using centrifugal force occurring when the rotor rotates.

### BRIEF DESCRIPTION OF DRAWINGS

FIG. 1 is a cross-sectional view of a generator of an embodiment of the present disclosure.

FIG. 2 is an enlarged cross-sectional view of the generator of the embodiment of the present disclosure.

FIG. 3 is a cross-sectional view of the generator of the embodiment of the present disclosure when viewed in an axial direction.

### DESCRIPTION OF EMBODIMENTS

Hereinafter, an embodiment of the present disclosure will be described with reference to the drawings.

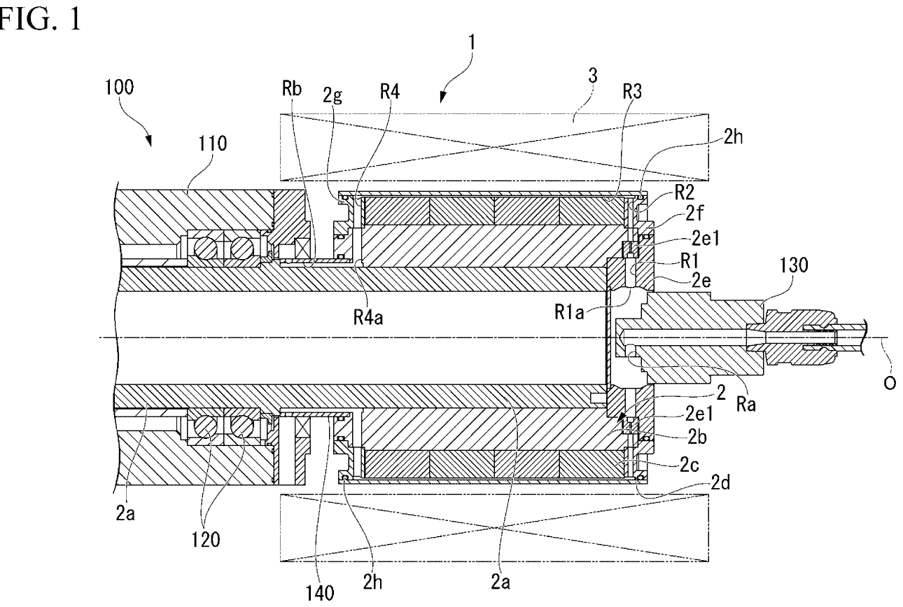

In the present embodiment, a generator will be described as an example of a rotation device. As shown in FIG. 1, a generator 1 is included in a power generation device 100. The power generation device 100 includes a casing 110, bearings 120, a cooling oil supply portion 130, a collar 140, the generator 1, and a rotation drive device such as vanes (not shown). The power generation device 100 is a device that generates electricity by rotating a rotor 2, which will be described later, of the generator 1 by the rotation drive device (not shown).

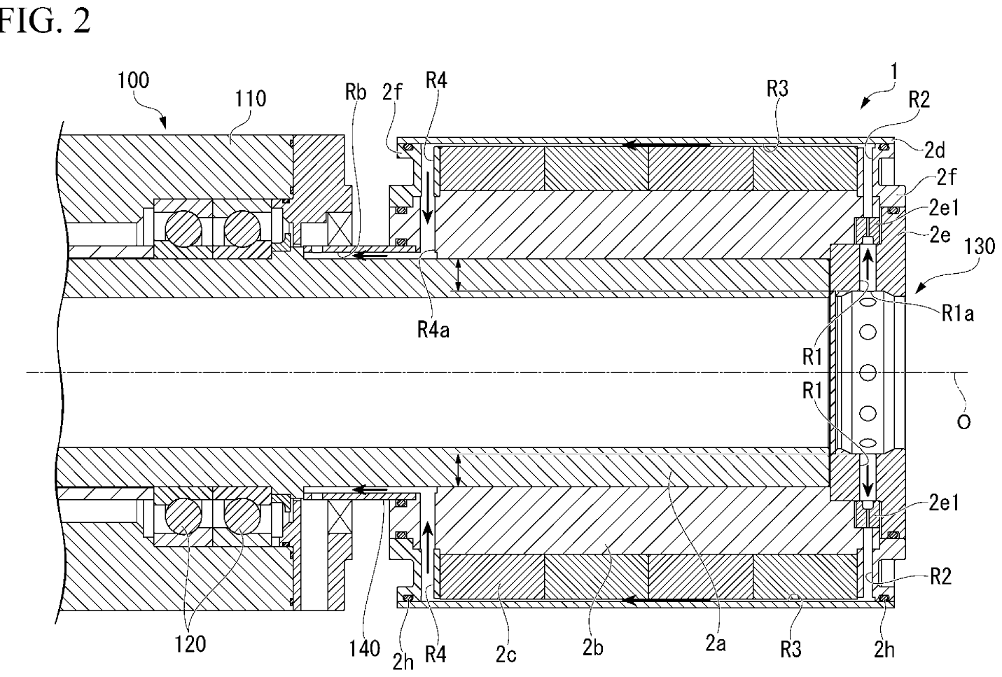

As shown in FIGS. 1 and 2, the generator 1 (i.e., a rotation device) includes the rotor 2 and a stator 3, and flow passages R1 to R4 are provided in several members.

The rotor 2 is rotatably held on the inside of the stator 3. The rotor 2 includes an inner shaft 2a (i.e., a rotation shaft), an outer shaft 2b, permanent magnets 2c, a magnet holder 2d, an end member 2e, a first end-holding ring 2f, a second end-holding ring 2g, and sealing members 2h.

In the present embodiment, the flow passages R1 to R4 are provided in the rotor 2, and the generator 1 includes the flow passages R1 to R4.

In the following description, a direction along a central axis O (i.e., a rotation axis, in other words, a rotation axis line) of the rotor 2 is referred to as an axial direction, a direction intersecting the central axis O when viewed in the axial direction is referred to as a radial direction, and a direction around the central axis O is referred to as a circumferential direction. The phrase “cross-sectional view when viewed in the axial direction” means a cross-sectional view including a plane orthogonal to the central axis O.

The inner shaft 2a is a cylindrical member and is fixed to the outer shaft 2b. The inner shaft 2a is fixed to the inner side of the outer shaft 2b. The inner shaft 2a is longer than the outer shaft 2b, and one end (i.e., the end closer to the casing 110) of the inner shaft 2a protrudes from the outer shaft 2b. The inner shaft 2a protrudes from the end surface on an outlet flow passage R4 (will be described later) side of the rotor 2 in the axial direction along the rotation axis. The inner shaft 2a is rotationally symmetrical with respect to the rotation axis.

The inner shaft 2a may be a solid round bar-shaped member. The inner shaft 2a protrudes from the end surface on the outlet flow passage R4-side of the outer shaft 2b in the axial direction.

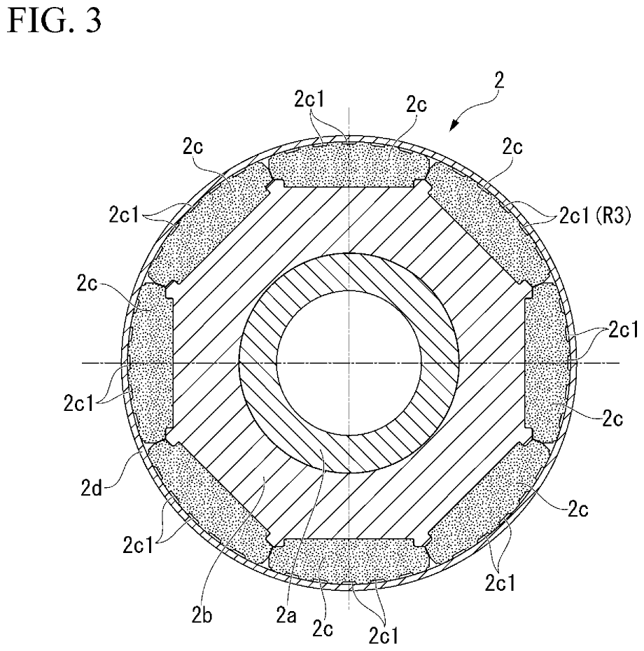

The outer shaft 2b is a cylindrical member. As shown in FIG. 3, the outer periphery of the outer shaft 2b has a substantially octagonal shape, and as shown in FIG. 2, the outer shaft 2b has an octagonal columnar outer shape. Each of the permanent magnets 2c is provided on one of eight flat surfaces of the outer peripheral surface of the outer shaft 2b, and the outer shaft 2b and the permanent magnets 2c are housed in the magnet holder 2d.

The inner shaft 2a has a diameter of less than that of the outer shaft 2b.

The permanent magnets 2c are fixed to surfaces (flat surfaces) of the outer shaft 2b and partially contact the magnet holder 2d. That is, each permanent magnet 2c is held in a state of being sandwiched between the outer shaft 2b and the magnet holder 2d. As shown in FIG. 3, the surface of each permanent magnet 2c, which contacts the magnet holder 2d, is provided with a plurality of flow passage grooves 2c1, which are along a longitudinal direction (i.e., the axial direction) and parallel to each other. The flow passage grooves 2c1 are linearly formed in an area between two ends in the axial direction of the permanent magnet 2c.

The magnet holder 2d has a cylindrical shape, and the outer shaft 2b holding the permanent magnets 2c is fixed thereto in a state where the outer shaft 2b is housed thereinside. The radially inner side of the magnet holder 2d partially contacts the permanent magnet 2c, and the permanent magnet 2c is held between the magnet holder 2d and the outer shaft 2b. A groove flow passage R3 (i.e., an axial flow passage), which guides cooling oil, is formed of the flow passage groove 2c1 of the permanent magnet 2c, at a position between the magnet holder 2d and the permanent magnet 2c.

The magnet holder 2d is made of, for example, a non-magnetic material (e.g., austenitic stainless steel).

The end member 2e is an annular member attached to ends (i.e., the ends closer to the cooling oil supply portion 130) in the axial direction of the inner shaft 2a and the outer shaft 2b and is connected to the cooling oil supply portion 130. The end member 2e is provided with inlet flow passages R1 that are radially formed at regular intervals in the circumferential direction. The inlet flow passages R1 are connected to flow passages Ra that will be described later. The inlet flow passage R1 is provided with a choke portion 2e1 in which the flow passage diameter thereof is decreased. The choke portion 2e1 decreases the flow rate through the inlet flow passage R1 so that the flow rates of the inlet flow passages R1 become equal.

The first end-holding ring 2f is an annular member and is provided at ends of the permanent magnets 2c and the outer shaft 2b, and the ends are positioned to be close to the end of the inner shaft 2a (i.e., the right side end in FIG. 2, the end on the cooling oil supply portion 130-side). The first end-holding ring 2f is provided with radial flow passages R2 connected to the inlet flow passages R1. The radial flow passages R2 are connected to the groove flow passages R3. The outer peripheral surface of the first end-holding ring 2f, which contacts the magnet holder 2d, is provided with the sealing member 2h.

The first end-holding ring 2f is provided on the outside in the radial direction of the end member 2e. The radial flow passages R2 are each connected to the inlet flow passages R1. The groove flow passage R3 (i.e., the axial flow passage) is connected to the inlet flow passage R1 through the radial flow passage R2.

The second end-holding ring 2g is an annular member and is provided at ends of the permanent magnets 2c and the outer shaft 2b in a state of facing the first end-holding ring 2f in the axial direction. The second end-holding ring 2g holds the permanent magnets 2c and the outer shaft 2b in a state where the permanent magnets 2c and the outer shaft 2b are sandwiched between the second end-holding ring 2g and the first end-holding ring 2f in the axial direction. An inner part of the second end-holding ring 2g is provided with the outlet flow passages R4 radially formed. Outlets R4a of the outlet flow passages R4 are connected to a flow passage Rb, which will be described later, and communicate with (in other words, reach) the outer peripheral surface of the inner shaft 2a. The second end-holding ring 2g is provided with the sealing member 2h at the contact portion between the second end-holding ring 2g and the magnet holder 2d.

As shown in FIG. 2, inlets R1a of the inlet flow passages R1 are provided on the inside in the radial direction of the outlets R4a of the outlet flow passages R4. The flow passages R1 to R4 are connected in this order and thus form a flow passage, which extends from the vicinity of the center in the radial direction of the rotor 2 toward the outside in the radial direction of the rotor 2, then extends in the axial direction, and then extends toward the inside in the radial direction of the rotor 2 again.

The sealing members 2h are, for example, O-rings that seal portions between the first end-holding ring 2f and the magnet holder 2d and between the second end-holding ring 2g and the magnet holder 2d.

As shown in FIGS. 1 and 2, the stator 3 is disposed, with a gap, on the outside in the radial direction of the magnet holder 2d. The stator 3 includes stator iron cores (not shown) and windings (not shown) wound around the stator iron cores.

The casing 110 has a substantially cylindrical shape and houses, with a slight gap, one end of the inner shaft 2a exposed from the outer shaft 2b.

The bearings 120 are provided in the vicinity of an end of the stator 3 of the generator 1 in a state of being fixed to the casing 110 and supports the inner shaft 2a such that the inner shaft 2a is rotatable.

The cooling oil supply portion 130 is a flow passage member provided at the end of the inner shaft 2a. The cooling oil supply portion 130 is connected to an external cooling oil supply device (not shown) and is provided with the flow passages Ra that radially branch outward in the radial direction. The flow passages Ra are connected to the inlet flow passages R1.

The cooling oil supply portion 130 and the casing 110 are provided at positions between which the outer shaft 2b is disposed in the axial direction. Although the flow passages Ra of the present embodiment extend in the radial direction, the flow passages Ra may extend in another direction such as the axial direction.

The collar 140 is an annular member provided, with a gap, on the outer peripheral surface of the inner shaft 2a, and the flow passage Rb is formed between the collar 140 and the outer peripheral surface of the inner shaft 2a. The flow passage Rb is connected to the outlet flow passages R4.

The collar 140 of the present embodiment is formed in a cylindrical shape and is provided at a position between the outer shaft 2b and the casing 110 in the axial direction. The flow passage Rb of the present embodiment does not extend in the radial direction but extends in the axial direction.

The flow passages Ra, R1 to R4 and Rb having the above configurations are connected in this order and thus form a cooling flow passage that guides, to positions between the permanent magnets 2c and the magnet holder 2d, cooling oil supplied from an external device (not shown).

Next, the flow of cooling oil in the power generation device 100 of the present embodiment will be described.

When the generator 1 is started, the inner shaft 2a and the outer shaft 2b are rotationally driven by vanes (not shown), so that the rotor 2 as a whole is rotated. This changes the magnetic field between the rotor 2 and the stator 3, and electric current flows through the windings of the stator 3. At this time, the magnet holder 2d, which is disposed in the outermost position in the radial direction of the rotor 2, is close to the permanent magnets 2c and the stator 3, and eddy current may be easily generated therein, so that the temperature of the magnet holder 2d may become high. For example, in the generator 1 of the present embodiment, the amount of heat generated in the magnet holder 2d is about several times the amount of heat (heat loss) generated in the permanent magnets 2c during driving, and the heat loss in the magnet holder 2d is greater than that in the permanent magnets 2c.

In the generator 1, the cooling oil flowed in from the cooling oil supply portion 130 flows into the inlet flow passages R1 through the flow passages Ra. At this time, since the flow passage diameter of the inlet flow passage R1 is decreased at the choke portion 2e1, the flow rate of the cooling oil passing through the inlet flow passage R1 is limited. The cooling oil overflowed thereby flows into another inlet flow passage R1 so that the flow rates of the inlet flow passages R1 become substantially equal. Then, a force outward in the radial direction due to the centrifugal force of the rotating rotor 2 is applied to the cooling oil, and the cooling oil flows through the radial flow passages R2 into the groove flow passages R3 formed between the permanent magnets 2c and the magnet holder 2d. The cooling oil in the groove flow passages R3 is extruded in the rotation axis direction and is led toward the outlet flow passages R4. At this time, the cooling oil comes into contact with the permanent magnets 2c and the magnet holder 2d having high temperatures in the groove flow passages R3 and removes the heat of the permanent magnets 2c and the magnet holder 2d by heat transfer. Then, the cooling oil flowed into the outlet flow passages R4 and flowed out therefrom flows into the flow passage Rb between the collar 140 and the inner shaft 2a. The cooling oil is stored in a space (not shown) provided in the casing 110 through the flow passages R4. The cooling oil temporarily stored in the space is discharged to the outside by the operation of a pump or the like (not shown). The cooling oil flowing through the flow passages Ra and the flow passage Rb is in an almost atmospheric pressure state and is not easily affected by a pump or the like provided on the upstream side or the downstream side of the generator 1.

According to the present embodiment, in the generator 1, the inlet R1a of the inlet flow passage R1 is provided on the inside in the radial direction of the outlet R4a of the outlet flow passage R4, and the groove flow passage R3 is provided on the outside in the radial direction of the inlet R1a of the inlet flow passage R1 and the outlet R4a of the outlet flow passage R4. As a result, centrifugal force acts on the cooling oil between the outlet R4a and the inlet R1a, and the pressure on the inlet side of the cooling flow passage can be further increased than the pressure on the outlet side thereof. Therefore, it is possible to make the cooling oil flow in the cooling flow passage due to the centrifugal force exerted on the rotor 2.

In the present embodiment, the inlet R1a of the inlet flow passage R1 is provided on the inside in the radial direction of the outlet R4a of the outlet flow passage R4. Thereby, the centrifugal force applied to the cooling oil in the inlet flow passage R1 due to the rotation of the rotor 2 can become greater than that applied to the cooling oil in the outlet flow passage R4, and the difference in centrifugal force can create a flow of the cooling oil from the inlet flow passage R1 to the outlet flow passage R4 through the groove flow passage R3. Since the flow passage Rb extends in the axial direction, it is possible to limit the centrifugal force applied to the cooling oil in the flow passage Rb from affecting the cooling oil in the outlet flow passage R4.

If the cooling oil guided to the vicinity of the outer peripheral surface of the rotor 2 is discharged at the position, the cooling oil is led outward in the radial direction due to centrifugal force, so that the cooling oil may come into contact with the stator 3 provided on the outside in the radial direction of the rotor 2 or may flow into a space between the stator 3 and the rotor 2.

In the present disclosure, the outlet flow passages R4 that guide the cooling oil to the inside in the radial direction are provided, and thus the cooling oil that has passed through the groove flow passages R3 can be discharged after being returned to the outer peripheral surface of the inner shaft 2a. Specifically, the bearings 120 and the sealing members 2h are disposed on the inside in the radial direction of the magnet holder 2d provided with the groove flow passages R3. The cooling oil is guided to the inside in the radial direction through the outlet flow passages R4 after passing through the groove flow passages R3, whereby the cooling oil passes through the inside of the bearings 120 and the sealing members 2h and is discharged to the outside of the generator.

With the above configuration, it is possible to limit the discharged cooling oil from coming into contact with the stator 3 or flowing into a space between the stator 3 and the rotor 2.

By providing the sealing members 2h, it is possible to limit the cooling oil flowing through the cooling flow passage from leaking from a slight gap between the first end-holding ring 2f and the magnet holder 2d and from a slight gap between the second end-holding ring 2g and the magnet holder 2d.

Hereinbefore, the embodiment of the present disclosure has been described with reference to the drawings, but the present disclosure is not limited to the above embodiment. The various shapes and combinations of the components shown in the above-described embodiment are examples, and various modifications can be adopted based on design requirements and the like within the scope of the attached claims.

In the above embodiment, the generator 1 is described. However, the present disclosure is also applicable to, for example, a case where in an electric motor (i.e., the rotation device) using permanent magnets, a member such as a magnet holder having a high temperature is cooled.

In the above embodiment, the cooling oil is shown as an example of a cooling medium, but the type of the cooling medium is not limited as long as it is a fluid and does not interfere with the operation of the generator 1.

A cooling liquid other than cooling oil may be used as the cooling medium.

The above embodiment does not include a pump for pumping the cooling oil, but a pump may be provided. In the latter case, it is possible to increase the pumping power for the cooling oil in the generator 1.

In the above embodiment, the rotor 2 has a double structure of the inner shaft 2a and the outer shaft 2b, but the present disclosure is not limited thereto, and various modifications can be adopted based on design requirements and the like. For example, the rotor 2 may include a shaft in which the inner shaft 2a and the outer shaft 2b are integrated. Even if it is in this case, the flow passage Rb is provided between the integrated shaft and the collar 140.

In other words, the integrated shaft may include a first portion (corresponding to the outer shaft 2b) and a second portion (corresponding to the inner shaft 2a) protruding in the axial direction from the end surface in the axial direction of the first portion and having a diameter less than that of the first portion. In the above embodiment, the rotor 2 may include an outer shaft 2b and an inner shaft 2a protruding from the end surface on the outlet flow passage R4-side of the outer shaft 2b in the axial direction and having a diameter less than that of the outer shaft 2b.

In the above embodiment, the inlet flow passage R1 is connected to the groove flow passage R3 through the radial flow passage R2. However, the inlet flow passage R1 and the radial flow passage R2 may be integratedly regarded as an “inlet flow passage” of the present disclosure.

### INDUSTRIAL APPLICABILITY

The present disclosure can be applied to a rotation device such as a generator and an electric motor. According to the present disclosure, it is possible to make cooling oil flow in a cooling flow passage without depending on a supply device such as a pump.

### DESCRIPTION OF REFERENCE SIGNS

1 generator (rotation device)

2 rotor

2a inner shaft (rotation shaft)

2b outer shaft

2c permanent magnet

2c1 flow passage groove

2d magnet holder

2e end member

2e1 choke portion

2f first end-holding ring

2g second end-holding ring

2h sealing member

3 stator

100 power generation device

110 casing

120 bearing

130 cooling oil supply portion

140 collar

R1 inlet flow passage

R2 radial flow passage

R3 groove flow passage (axial flow passage)

R4 outlet flow passage

1. A rotation device, comprising:
a rotor,
wherein the rotor is provided with:
an inlet flow passage that guides a cooling medium toward an outside in a radial direction of the rotor;
an axial flow passage that is connected to the inlet flow passage and guides the cooling medium along a rotation axis of the rotor;
an outlet flow passage that is connected to the axial flow passage and guides the cooling medium toward an inside in the radial direction of the rotor; and
a flow passage connected to an outlet of the outlet flow passage and extending in an axial direction of the rotation axis, and
wherein an the outlet of the outlet flow passage is provided on an outside in the radial direction of an inlet of the inlet flow passage in the rotor.

2. The rotation device according to claim 1, comprising:
a rotation shaft protruding from an end surface on the outlet flow passage-side of the rotor in the axial direction of the rotation axis,
wherein the outlet of the outlet flow passage communicates with an outer peripheral surface of the rotation shaft, and
the flow passage extends in the axial direction on the outer peripheral surface of the rotation shaft.

3. (canceled)

4. The rotation device according to claim 1,
wherein the flow passage allows the cooling medium to be discharged to an outside of the rotation device therethrough.

5. The rotation device according to claim 1, comprising:
a stator provided on the outside in the radial direction of the rotor,
wherein the flow passage extends to a position equivalent in the axial direction to an end in the axial direction of the stator.

6. The rotation device according to claim 2, comprising:
a bearing supporting the rotation shaft such that the rotation shaft is rotatable,
wherein the flow passage allows the cooling medium to pass through an inside of the bearing and to be discharged to an outside of the rotation device.

7. The rotation device according to claim 2, comprising:
an annular collar provided on the outer peripheral surface of the rotation shaft with a gap,
wherein the flow passage is formed between the collar and the rotation shaft.

8. The rotation device according to claim 1,
wherein the axial flow passage is provided with a sealing member that limits the cooling medium from leaking.
